(19) United States
(12) Patent Application Publication
(10) Pub. No.: US 2025/0026571 A1
(43) Pub. Date: Jan. 23, 2025

(54) ENERGY REUSE SYSTEMS AND METHODS

(71) Applicant: INTELLIGRATED HEADQUARTERS, LLC, Mason, OH (US)

(72) Inventors: Frida Daniela Garcia de Hoyos, Santa Bárbara (MX); Isaac Ocana Garcia, Santa Bárbara (MX)

(21) Appl. No.: 18/354,876

(22) Filed: Jul. 19, 2023

(51) Int. Cl. B65G 13/07; H02K 7/14

(52) U.S. Cl. CPC B65G 13/07; H02K 7/14

(57) ABSTRACT

Systems, methods, and/or the like are provided. According to various embodiments, an energy reuse system is provided including a frame; a motor driven roller (MDR) disposed on or within the frame and configured to generate kinetic energy and drive one or more idler rollers; a dynamo configured to transform kinetic energy into electrical energy; a coupling device configured to operably connect the MDR to the dynamo and thereby transform the kinetic energy generated by the MDR into electrical energy; and a battery configured to store the electrical energy. In some embodiments, the coupling device includes a silicon gear ring. In some embodiments, the system includes an MDR bed disposed on or within the frame, and the MDR and the one or more idler rollers are disposed within the MDR bed.

### TECHNICAL FIELD

The present disclosure relates generally to energy reuse systems and methods. In particular, it relates to energy reuse systems and methods for use with motor-driven rollers in conveyor systems.

### BACKGROUND

Conveyor systems use multiple motor driven rollers (MDRs) to drive the conveyors. An MDR connected to multiple rollers and sensors may require a high amount of power consumption to function. In some cases, the power requirements may be as high as 24 volts. Power consumption is compounded by the user of multiple MDRs in a conveyor system.

Through applied effort, ingenuity, and innovation, the Applicants have solved problems relating to energy consumption by conveyor systems by developing solutions embodied in the present disclosure, which are described in detail below.

### SUMMARY

In general, embodiments of the present disclosure provide energy reuse systems, methods, and/or the like.

In accordance with various embodiments of the present disclosure there is provided an energy reuse system including: a frame; a motor driven roller (MDR) disposed on or within the frame and configured to generate kinetic energy and drive one or more idler rollers; a dynamo configured to transform kinetic energy into electrical energy; a coupling device configured to operably connect the MDR to the dynamo and thereby transform the kinetic energy generated by the MDR into electrical energy; and a battery configured to store the electrical energy.

In some embodiments, the coupling device includes a silicon gear ring.

In some embodiments, the energy reuse system further comprises an MDR bed disposed on or within the frame, and wherein the MDR and the one or more idler rollers are disposed within the MDR bed.

In some embodiments, the frame includes a metallic, rectangular frame.

In some embodiments, the energy reuse system further includes a sensor.

In some embodiments, the sensor includes a photo-eye sensor.

In some embodiments, the sensor is disposed beneath the frame.

In some embodiments, the energy reuse system further includes a control device configured to selectively provide the electrical energy stored in the battery to the MDR.

In some embodiments, the frame is disposed on or within one or more conveyor systems.

In some embodiments, the energy reuse system further includes an adhesive configured to operably connect the MDR, the coupling device, and the dynamo.

In some embodiments, the adhesive is a glue.

According to various embodiments, there is provided a method of using an energy reuse system, the method including activating, by a control device, a motor driven roller (MDR) such that the MDR generates kinetic energy and drives one or more idler rollers of a conveyor system; transforming, by a dynamo, the kinetic energy generated by the MDR into electrical energy; and powering, by the electrical energy, the MDR.

In some embodiments, the method further includes storing, by a battery, the electrical energy.

The above summary is provided merely for purposes of summarizing some example embodiments to provide a basic understanding of some embodiments of the disclosure. Accordingly, it will be appreciated that the above-described embodiments are merely examples. It will be appreciated that the scope of the disclosure encompasses many potential embodiments in addition to those here summarized, some of which will be further described below.

### BRIEF DESCRIPTION OF THE SEVERAL VIEWS OF THE DRAWING(S)

Having thus described the disclosure in general terms, reference will now be made to the accompanying drawings, which are not necessarily drawn to scale, and wherein:

FIG. 1 shows an elevated rear view of an example energy reuse system in accordance with various embodiments of the present disclosure;

FIG. 2 shows a detail view of an example energy reuse system in accordance with various embodiments of the present disclosure;

FIG. 3 shows a detail view of an example energy reuse system in accordance with various embodiments of the present disclosure;

FIG. 4 shows a schematic view of an example energy reuse system in accordance with various embodiments of the present disclosure; and

FIG. 5 shows a flow chart illustrating an example method of using an energy reuse system.

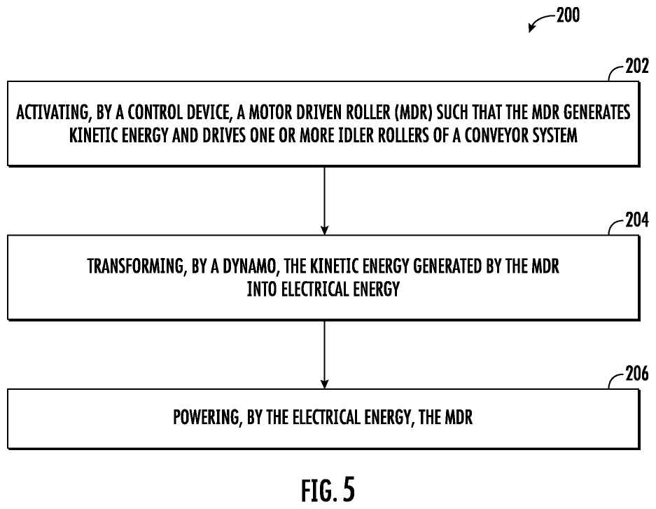

### DETAILED DESCRIPTION OF SOME EXAMPLE EMBODIMENTS

Various embodiments of the present disclosure now will be described more fully hereinafter with reference to the accompanying drawings, in which some, but not all embodiments of the disclosure are shown. Indeed, this disclosure may be embodied in many different forms and should not be construed as limited to the embodiments set forth herein; rather, these embodiments are provided so that this disclosure will satisfy applicable legal requirements. The term “or” (also designated as “/”) is used herein in both the alternative and conjunctive sense, unless otherwise indicated. The terms “illustrative” and “exemplary” are used to be examples with no indication of quality level. Like numbers may refer to like elements throughout. The phrases “in one embodiment,” “according to one embodiment,” and/or the like generally mean that the particular feature, structure, or characteristic following the phrase may be included in at least one embodiment of the present disclosure and may be included in more than one embodiment of the present disclosure (importantly, such phrases do not necessarily may refer to the same embodiment).

### Overview

According to various embodiments, there is provided an energy reuse system. The energy reuse system may be configured to convert kinetic energy generated by the motion of a motor driven roller (MDR) into electrical energy, which may then be stored and used to power the MDR; in at least this way, the energy reuse system may enable a feedback loop wherein the MDR may be powered at least in part by its own motion, thus conserving energy and subsequently mitigating potential drawbacks from high power consumption. In some embodiments, the energy reuse system may include a battery configured to store the electrical energy produced by the dynamo, as well as a control device configured to selectively control power distribution to the MDR.

### Example Energy Reuse Systems

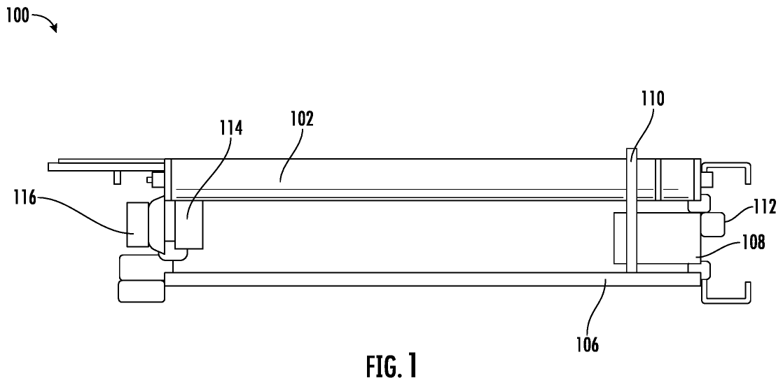

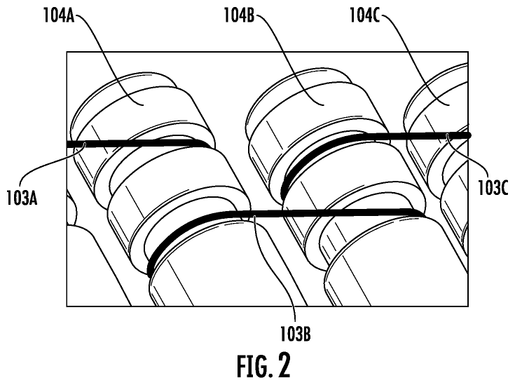

Referring now to FIG. 1, an elevated rear view of an example energy reuse system 100 (“the system 100”) is shown, according to various embodiments. In some embodiments, the energy reuse system 100 may include a motor driven roller (MDR) 102. The MDR 102 may be powered by an outside power supply 101 (e.g., 24 DC Volt electric connection) and configured to drive one or more idler rollers 104A-C (as shown in FIG. 2). The MDR 102 may be configured to generate kinetic energy as it rotates to drive the one or more idler rollers 104A-C. In some embodiments, the MDR 102 may be coupled to the one or more idler rollers 104A-C by one or more pulleys 103A-C. In some embodiments, the MDR and the one or more idler rollers may comprise a roller bed, which may be disposed on or within a frame 106 of the energy reuse system 100. In some embodiments, the frame 106 may be a substantially metallic, rectangular frame. In some embodiments, the MDR 102 may be configured to drive the one or more idler rollers 104A-C and thereby convey one or more objects. In some embodiments, the MDR 102 and the one or more idler rollers 104A-C may comprise a conveyor system and/or be disposed on or within a conveyor system.

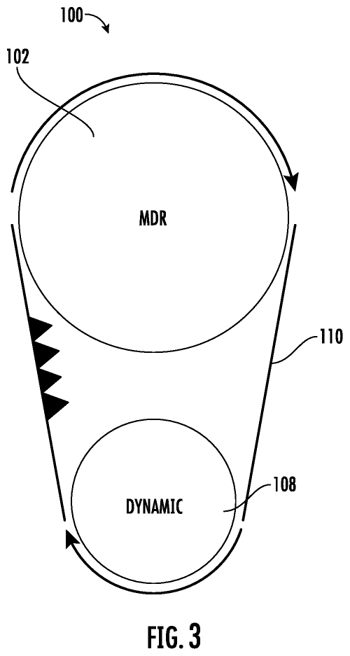

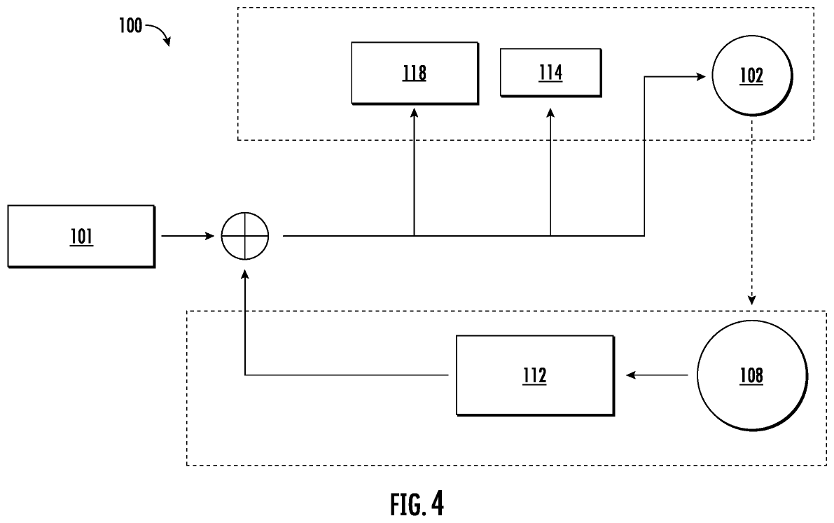

Referring again to FIG. 1, but also to FIG. 3, which shows a detail view of the example energy reuse system 100, and FIG. 4, which shows a schematic view of an example energy reuse system 100, in some embodiments, the system 100 may include a dynamo 108. In some embodiments, the dynamo 108 may be configured to convert the kinetic energy generated by the MDR 102 into electrical energy. In some embodiments, the energy reuse system 100 may include a coupling device 110 configured to operably connect the MDR 102 to the dynamo 108. In some embodiments, when the MDR 102 and the dynamo 108 are operably connected, the dynamo 108 may be configured to rotate with the MDR 102. In some embodiments, the coupling device 110 may be a silicon gear ring. In some embodiments, and as shown in at least FIG. 1, the dynamo 108 may be disposed within the frame 106 and may be disposed below the MDR 102.

Referring again to FIG. 1, but also to FIG. 4, the system 100 may also include a battery 112, according to various embodiments. In some embodiments, the battery 112 may be operably engaged with one or more of the MDR 102 and/or the dynamo 108. In some embodiments, the battery 112 may be configured to store the electrical energy generated by the dynamo 108 that is converted from the kinetic energy generated by the MDR 102. In some embodiments, the battery 112 may be a 24 DC Volt, 20 Amp-hour battery pack. In some embodiments, the battery 112 may be disposed on or within the frame 106, and may be disposed below the MDR 102. In some embodiments, the battery 112 may be configured to supply electrical energy to various components of the energy reuse system 100, including but not limited to the MDR 102.

Referring again to FIG. 1, but also to FIG. 4, in some embodiments, the energy reuse system 100 may include a sensor 114. In some embodiments, the sensor 114 may be a photoeye sensor. The photoeye sensor 114 may be configured to detect if any product is being conveyed through or by the MDR 102, or a section of the system 100. In some embodiments, the sensor 114 may be disposed on or within the frame 106 and/or below the MDR 102.

In some embodiments, the energy reuse system 100 includes a control device 116. In some embodiments, the control device 116 may include one or more processors, one or more wireless communication components, and one or more memory devices for storing information in the short and/or long-term. In some embodiments, the control device 116 may be configured to selectively control if/when electrical energy is being supplied from the batter 112 to the MDR 102. In some embodiments, the control device 116 may be configured to automatically transfer electrical energy from the battery 112 to the MDR 102 depending on one or more factors (e.g., energy usage of the MDR 102).

In some embodiments, referring now to FIG. 4, the energy reuse system 100 may include a communications module 118. In some embodiments the communications module 118 may be separated from one or more other components of the system 100. The communications module 118 may be a BnR module configured to send a signal to one or more external components. For example, the communications module 118 may be configured to send a signal to an external component reporting on the status of the photoeye sensor 114 and/or the MDR 102. It will be understood that the communications module 118 may fulfill a wide variety of uses.

### Example Methods of Use for Example Energy Reuse Systems

According to various embodiments, there is provided a method 200 of using one or more example energy reuse systems. The method 200 is described with respect to the energy reuse system 100 and its various components. It will be understood that the method 200 may be implemented using any number of suitable systems and components as desired.

In some embodiments, the method 200 may include a step 202 of activating, by a control device, a motor driven roller (MDR) such that the MDR generates kinetic energy and drives one or more idler rollers of a conveyor system. In some embodiments, the method 200 may include a step 204 of transforming, by a dynamo, the kinetic energy generated by the MDR into electrical energy. In some embodiments, the method 200 may include a step 206 of powering, by the electrical energy, the MDR. In some embodiments, the method 200 may include additional steps including, but not limited to, storing, by a battery, the electrical energy converted from kinetic energy by the dynamo.

Many modifications and other embodiments of the disclosure set forth herein will come to mind to one skilled in the art to which this disclosure pertains having the benefit of the teachings presented in the foregoing descriptions and the associated drawings. Therefore, it is to be understood that the disclosure is not to be limited to the specific embodiments disclosed and that modifications and other embodiments are intended to be included within the scope of the appended claims. Although specific terms are employed herein, they are used in a generic and descriptive sense only and not for purposes of limitation.

1. An energy reuse system comprising:
a frame;
a motor driven roller (MDR) disposed on or within the frame and configured to generate kinetic energy and drive one or more idler rollers;
a dynamo configured to transform kinetic energy into electrical energy;
a coupling device configured to operably connect the MDR to the dynamo and thereby transform the kinetic energy generated by the MDR into electrical energy; and
a battery configured to store the electrical energy.

2. The energy reuse system of claim 1, wherein the coupling device comprises a silicon gear ring.

3. The energy reuse system of claim 1, further comprising an MDR bed disposed on or within the frame, and wherein the MDR and the one or more idler rollers are disposed within the MDR bed.

4. The energy reuse system of claim 1, wherein the frame comprises a metallic, rectangular frame.

5. The energy reuse system of claim 1, further comprising a sensor.

6. The energy reuse system of claim 5, wherein the sensor comprises a photo-eye sensor.

7. The energy reuse system of claim 5, wherein the sensor is disposed beneath the frame.

8. The energy reuse system of claim 1, further comprising a control device configured to selectively provide the electrical energy stored in the battery to the MDR.

9. The energy reuse system of claim 1, wherein the frame is disposed on or within one or more conveyor systems.

10. The energy reuse system of claim 1, further comprising an adhesive configured to operably connect the MDR, the coupling device, and the dynamo.

11. The energy reuse system of claim 10, wherein the adhesive comprises a glue.

12. A method of using an energy reuse system, the method comprising:
activating, by a control device, a motor driven roller (MDR) such that the MDR generates kinetic energy and drives one or more idler rollers of a conveyor system;
transforming, by a dynamo, the kinetic energy generated by the MDR into electrical energy; and
powering, by the electrical energy, the MDR.

13. The method of claim 12, further comprising storing, by a battery, the electrical energy.
